(19) United States
(12) Patent Application Publication
(10) Pub. No.: US 2007/0049258 A1
(43) Pub. Date: Mar. 1, 2007

(54) SYSTEM AND METHOD OF MOBILE TO DESKTOP DOCUMENT INTERACTION USING REALLY SIMPLE SYNDICATION

(76) Inventor: Jason Thibeault, Chandler, AZ (US)

Correspondence Address: ZARETSKY & ASSOCIATES PC, 8753 W. RUNION DR., PEORIA, AZ, 85382-6412, US

(21) Appl. No.: 11/468,291

(22) Filed: Aug. 29, 2006

Related U.S. Application Data
(60) Provisional application No. 60/712,745, filed on Aug. 30, 2005.

(51) Int. Cl. H04Q 7/38

(52) U.S. Cl. 455/414.1

(57) ABSTRACT

A novel system and method for initiating, via a mobile device utilizing really simple syndication (RSS), the sending of messages from a user's desktop computer to one or more recipients. The mechanism establishes a connection between the mobile device and the user's PC whereby data is served from the user's PC to the mobile device to permit the mobile user to make document and recipient selections. A conventional email application at the user's PC generates and sends the messages which may be sent with or without attachments (e.g., documents) depending on the mobile user's preference. Document and recipient lists in RSS format (or any other suitable format) are provided to the mobile device for display to the mobile user. The mobile user makes document and recipient selections which are conveyed to the user PC. The user PC generates and sends the requested messages with the selected documents to each of the recipients on the received contact list.

### REFERENCE TO PRIORITY APPLICATION

This application claims priority under 35 U.S.C. §119(e) to U.S. Provisional Application Ser. No. 60/712,745, filed Aug. 30, 2005, entitled “System and Method for Sending A Document to a Recipient Via Email From A PC Using A Mobile Phone,” incorporated herein by reference in its entirety.

### FIELD OF THE INVENTION

The present invention relates to the field of data communications and more particularly relates to a system and method for initiating the sending of messages with or without attachments (e.g., documents) from a user PC to one or more recipients via a mobile device utilizing Really Simple Syndication (RSS) protocol.

### BACKGROUND OF THE INVENTION

In recent years the number of computers in use is increasing at an ever quickening pace. Along with the huge increase in the number of computers in use around the world, is a parallel increase in the number of computers connected to the Internet. Further, the world is witnessing an explosion of wireless devices that have the capability of connecting to the Internet as well. Such wireless devices include, for example, laptop computers, notebooks, palmtops, PDAs, cellular telephones with email and web browsing capabilities and other mobile wireless devices.

The Really Simple Syndication (RSS) format is widely used today to represent documents for delivery to a target or client computing device. It is commonly used by news organizations to distribute news feeds to a large number of subscribers or ‘bloggers’ to provide a mechanism for their readers to receive timely updates without having to frequently visit the blog site itself. Rather than requiring users to click on individual items at a news website, users subscribe to an RSS news feed. Once subscribed, users are automatically sent a copy of the news item when it is published by the news server.

Every object that can be identified through a Uniform Resource Identifier (URI) or Uniform Resource Locator (URL) is a resource that can be embedded in an RSS document. An RSS document contains information about which information objects are to be found under a URI. In addition, it can include a description of the resource and the individual information objects, the specification of a unique identifier for the objects and other information.

The number of mobile handsets and mobile devices in use within the general population has exploded in recent years. Moreover, the proliferation of mobile handsets and devices within the enterprise has matched the growth within the general population. As a consequence, enterprises are beginning to invest considerable resources in mobile applications that allow direct communication between the mobile devices and servers and desktop computers. This has enabled a growing workforce that is capable of conducting business while away from the desk, office, and most importantly, the desktop computer.

A block diagram illustrating a prior art example network incorporating an enterprise, mobile users and a recipient is shown in FIG. 1. The example network, generally referenced 10, comprises an enterprise site 12 having an enterprise LAN 13 connecting together a plurality of user PCs 14. The enterprise LAN is connected to the Internet 11. Also connected to the Internet are a recipient PC 20 and wireless base station 18. The base station provides wireless services to a plurality of cell phones 17 and other mobile devices 19 (e.g., PDAs, Blackberrys, Treos, etc.) in use by mobile users 16.

There still remains, however, a significant disconnect between the enterprise desktop computer 14 and the mobile devices used by the mobile workforce 16. Employees with mobile phones 17 and mobile devices 19 are unable to interact with documents and applications running on their desktop computers 14 connected to the enterprise LAN 13 because of the inherent incompatibility between mobile and typical office computing platforms (e.g., different operating systems, etc.). As a result, when an employee is out of the office, she/he is unable to interact with or manipulate documents required by clients or other employees. How often does a member of the mobile workforce find herself/himself out of the office and away from their enterprise desktop computer when a request for a document is received from a colleague, for example? This prompts the quintessential reply, “I'll get you that document as soon as I get back in the office.”

The inability of a mobile user to interact in real time with documents on her/his desktop computer thus results in potentially significant loss of productivity. Currently, if the user (e.g., employee) is out of the office, requesters must wait for the user to return before obtaining the requested documents. If the request is urgent, either the requester spends possibly considerable effort to obtain the documents from other sources or tolerates the wait until the user returns to her/his office.

There is thus a need for a mechanism that overcomes the disadvantages of the prior art. In particular, there is a need for a mechanism that is capable of providing a direct link between mobile devices and enterprise based desktop workstations that provide the mobile workforce a mechanism for document interaction.

### SUMMARY OF THE INVENTION

The present invention is a system and method for initiating the sending of messages from a user's desktop computer to one or more recipients via a mobile device utilizing really simple syndication (RSS). The mechanism establishes a connection between the mobile device and the user's PC whereby data is served from the user's PC to the mobile device to permit the mobile user to make document and recipient selections. A conventional email application at the user's PC generates and sends the messages which may be sent with or without attachments (e.g., documents) depending on the mobile user's preference.

The document attachments may comprise any document type (i.e. file type) that could normally be sent in a conventional email message. The invention provides mechanisms for selecting documents and recipient email addresses with and without the use of a middleware application running on the mobile device. The invention also provides mechanisms for (1) generating contact (i.e. recipient) lists from a personal information manager (PIM) into RSS, (2) generating lists of document located on a user's hard drive into RSS, and (3) delivering RSS based document and contact list documents to the mobile device for presentation to the mobile user. A mechanism executing on the mobile device permits a mobile user to select documents and recipients from the RSS lists received from the user's PC.

An authentication server, in communication with both the mobile device and the user's PC, is used to verify users against a database maintained by the authentication server. Enterprise desktop users and mobile users go through a registration process on the authentication server. Access to users' PCs from mobile devices is controlled by the authentication server. Once registration is complete, a mobile device can request a connection to a user PC. In response to the request, the authentication service provides the IP address or other related connection data to the mobile device. Using the data received from the authentication service, the mobile device establishes direct communications between itself and the user's PC located in the enterprise.

Document and recipient lists in RSS format (or any other suitable format) are then provided to the mobile device for display to the mobile user. The mobile user makes document and recipient selections which are conveyed to the user PC. The user PC generates and sends the requested messages with the selected documents to each of the recipients on the received contact list.

Note that some aspects of the invention described herein may be constructed as software objects that are executed in embedded devices as firmware, software objects that are executed as part of a software application on either an embedded or non-embedded computer system such as a central processing unit (CPU), digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the present invention, a method of document interaction between a mobile device and a user computer in communication with each other via one or more communication networks, the method comprising the steps of transmitting to the mobile device a document list and a recipient list generated by the user computer, displaying on the mobile device the document list and the recipient list for selection by a mobile user, transmitting selected documents and selected recipients chosen by a mobile user to the user computer, generating a message incorporating the selected documents and transmitting the message from the user computer to each of the selected recipients.

There is also provided in accordance with the present invention, a method of document interaction, for use on a mobile device, between a mobile device and a user computer in communication with each other via one or more communication networks, the method comprising the steps of displaying on the mobile device a document list and a recipient list to a mobile user for selection by a mobile user, transmitting selected documents and selected recipients chosen by a mobile user to the user computer and receiving a confirmation message on the mobile device from the user computer indicating successful transmission of a message incorporating the selected documents to each of the selected recipients.

There is further provided in accordance with the present invention, a mobile client for document interaction with a user computer, the mobile client and the user computer in communication with each other via one or more communication networks, the mobile client comprising display means for displaying on the mobile device a document list and a recipient list to a mobile user and for receiving document selections and recipient selections chosen by a mobile user, means for transmitting the selected documents and the selected recipients to the user computer and means for receiving a confirmation message on the mobile device from the user computer indicating successful transmission of a message incorporating the selected documents to each of the selected recipients.

There is also provided in accordance with the present invention, a computer program product comprising a computer usable medium having computer usable program code for document interaction between a mobile device and a user computer in communication with each other via one or more communication networks, the computer program product including, computer usable program code for displaying on the mobile device a document list and a recipient list to a mobile user for selection by a mobile user, computer usable program code for transmitting selected documents and selected recipients chosen by a mobile user to the user computer and computer usable program code for receiving a confirmation message on the mobile device from the user computer indicating successful transmission of a message incorporating the selected documents to each of the selected recipients.

There is further provided in accordance with the present invention, a method of document interaction, for use on a user computer, between a mobile device and a user computer in communication with each other via one or more communication networks, the method comprising the steps of providing a document list and a recipient list to a mobile device for selection by a mobile user, receiving selected documents and selected recipients chosen by the mobile user, generating a message incorporating the selected documents and transmitting the message from the user computer to each of the selected recipients.

There is also provided in accordance with the present invention, a computer program product comprising a computer usable medium having computer usable program code for document interaction between a mobile device and a user computer in communication with each other via one or more communication networks, the computer program product including, computer usable program code for providing a document list and a recipient list to a mobile device for selection by a mobile user, computer usable program code for receiving selected documents and selected recipients chosen by the mobile user, computer usable program code for generating a message incorporating the selected documents and computer usable program code for transmitting the message from the user computer to each of the selected recipients.

There is further provided in accordance with the present invention, an apparatus for document interaction with a mobile device, the apparatus and the mobile user in communication with each other via one or more communication networks, the apparatus comprising an activity database for storing session based information related to generation of messages for transmission to one or more recipients, a web server operative to receive requests from and to serve document and recipient lists to the mobile device, a messaging application operative to generate and transmit messages to one or more recipients and an agent in communication with the activity database, the web server and the messaging application, the agent operative to generate the document and recipient lists for selection by a mobile user on the mobile device, to receive selected documents and selected recipients chosen by the mobile user and to generate and transmit a message containing the selected documents to each of the selected recipients.

### BRIEF DESCRIPTION OF THE DRAWINGS

The invention is herein described, by way of example only, with reference to the accompanying drawings, wherein:

FIG. 1 is a block diagram illustrating a prior art example network incorporating an enterprise, mobile users and a recipient;

FIG. 2 is a block diagram illustrating an example network incorporating a mobile user and a user PC adapted to execute the RSS based document interaction application of the present invention;

FIG. 3 is a block diagram illustrating an example computer processing system architecture suitable for use with the present invention.

FIG. 4 is a block diagram illustrating an example mobile device or PDA system architecture suitable for use with the present invention.

FIG. 5 is a block diagram illustrating the authentication server of the present invention in more detail;

FIG. 6 is a block diagram illustrating the mobile client (MC) of the present invention in more detail;

FIG. 7 is a block diagram illustrating the user PC and the send document agent of the present invention in more detail;

FIG. 8 is a block diagram illustrating the processing sequence of the RSS based document interaction mechanism of the present invention;

FIG. 9 is a flow diagram illustrating the user PC based send document method of the present invention;

FIG. 10 is a flow diagram illustrating the mobile client based send document method of the present invention;

FIG. 11 is a flow diagram illustrating the agent/PIM data transfer method of the present invention;

FIG. 12 is a flow diagram illustrating the email address method of the present invention with no middleware application on the mobile device; and

FIG. 13 is a flow diagram illustrating the email address method of the present invention with a middleware application on the mobile device.

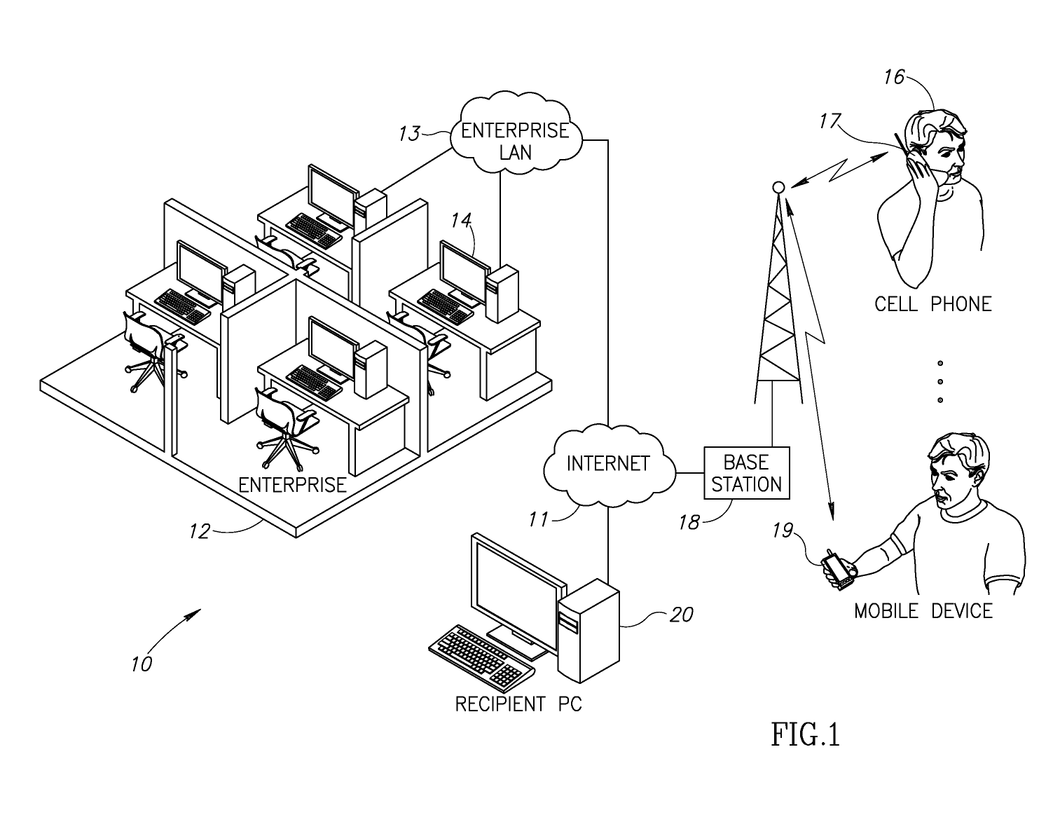

### DETAILED DESCRIPTION OF THE INVENTION

### Notation Used Throughout

The following notation is used throughout this document.

| Term | Definition |
|---|---|
| AC | Alternating Current |
| API | Application Programming Interface |
| ASIC | Application Specific Integrated Circuit |
| CD-ROM | Compact Disc-Read Only Memory |
| CPU | Central Processing Unit |
| DC | Direct Current |
| DSP | Digital Signal Processor |
| EEROM | Electrically Erasable Read Only Memory |
| EPROM | Erasable Programmable Read Only Memory |
| FM | Frequency Modulation |
| FPGA | Field Programmable Gate Array |
| FTP | File Transfer Protocol |
| GUI | Graphical User Interface |
| HDD | Hard Disk Drive |
| HDL | Hardware Description Language |
| HTML | Hypertext Markup Language |
| HTTP | Hypertext Transfer Protocol |
| HTTPS | SSL secured HTTP |
| I/F | Interface |
| ID | Identification |
| IM | Internet Messaging |
| IP | Internet Protocol |
| ISP | Internet Service Provider |
| LAN | Local Area Network |
| MAC | Media Access Control |
| MC | Mobile Client |
| MD5 | Message-Digest algorithm 5 |
| NIC | Network Interface Card |
| PC | Personal Computer |
| PDA | Personal Digital Assistant |
| PIM | Personal Information Manager |
| RAM | Random Access Memory |
| ROM | Read Only Memory |
| RSA | Rivest Shamir Adleman encryption algorithm |
| RSS | Really Simple Syndication |
| SDA | Send Document Agent |
| SIM | Subscriber Identity Module |
| SMS | Short Message Service |
| SSL | Secure Sockets Layer |
| URI | Uniform Resource Identifier |
| URL | Uniform Resource Locator |
| USB | Universal Serial Bus |
| UWB | Ultra Wideband |
| WAN | Wide Area Network. |
| WAP | Wireless Application Protocol |
| WLAN | Wireless Local Area Network |
| WWAN | Wireless Wide Area Network |
| XHTML | Extensible HyperText Markup Language |
| XML | Extensible Markup Language |
| XSTL | eXtensible Style Sheet Language Transformation |

The present invention is a system and method for initiating the sending of messages from a user's desktop computer (hereinafter “user PC”) to one or more recipients via a mobile device utilizing really simple syndication (RSS). The mechanism establishes a connection between the mobile device and the user's PC whereby data is served from the user's PC to the mobile device to permit the mobile user to make document and recipient selections. A conventional email application at the user's PC generates and sends the messages which may be sent with or without attachments (e.g., documents) depending on the mobile user's preference.

The document attachments may comprise any document type (i.e. file type) that could normally be sent in a conventional email message. The invention provides mechanisms for selecting documents and recipient email addresses with and without the use of a middleware application on the mobile device. The invention also provides mechanisms for (1) generating contact (i.e. recipient) lists from a personal information manager (PIM) into RSS, (2) generating lists of document located on a user's hard drive into RSS, and (3) delivering RSS based document and contact list documents to the mobile device for presentation to the mobile user. A mechanism executing on the mobile device permits a mobile user to select documents and recipients from the RSS lists received from the user's PC.

An authentication server, in communication with both the mobile device and the user's PC, is used to verify users against a database maintained by the authentication server. Enterprise desktop users and mobile users go through a registration process on the authentication server. Access to users' PCs from mobile devices is controlled by the authentication server. Once registration is complete, a mobile device can request a connection to a user PC. In response to the request, the authentication service provides the IP address or other related connection data to the mobile device. Using the data received from the authentication service, the mobile device establishes direct communications between itself and the user's PC located in the enterprise.

Document and recipient lists in RSS format (or any other suitable format) are then provided to the mobile device for display to the mobile user. The mobile user makes document and recipient selections which are conveyed to the user PC. The user PC generates and sends the requested messages with the selected documents to each of the recipients on the received contact list.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In a preferred embodiment, the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

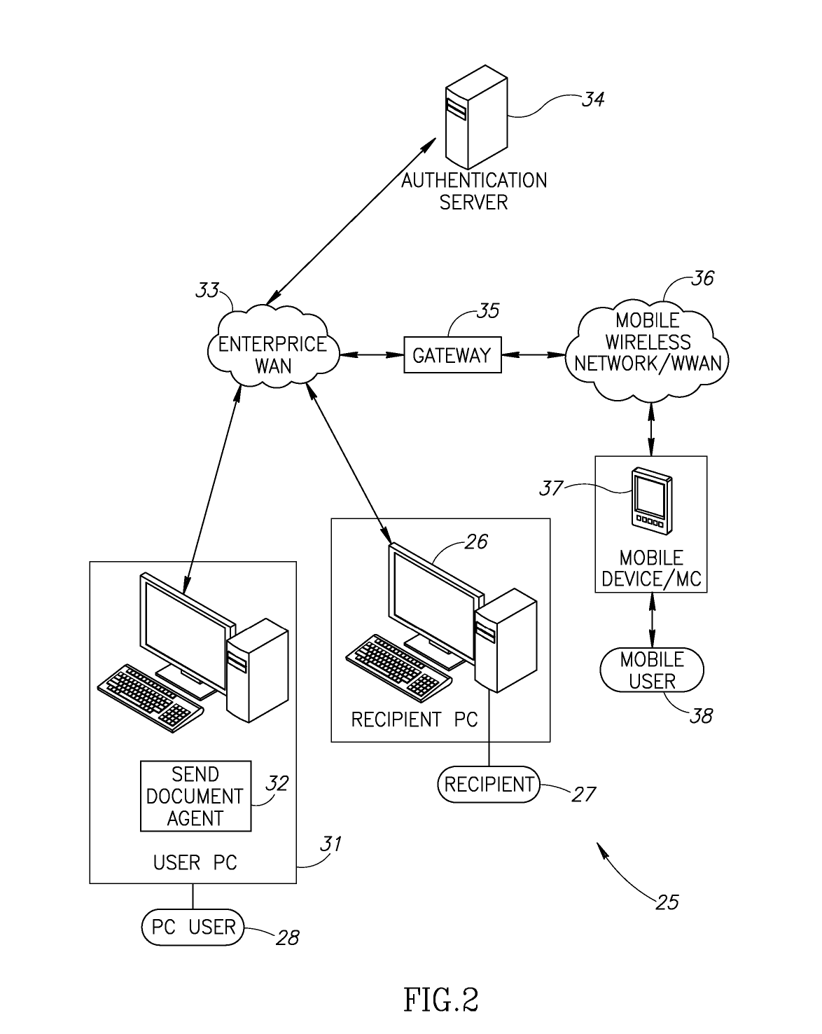

A block diagram illustrating an example network incorporating a mobile client (MC), authentication server and a user PC, all constructed in accordance with the present invention is shown in FIG. 2. The example network, generally referenced 25, comprises an Internet/WAN/WWAN cloud 33, one or more mobile users 38 and mobile devices 37, one or more recipients 27 and recipient PCs 26, an authentication server 34, gateway 35, mobile wireless network 36, e.g., Wireless Wide Area Network (WWAN) and one or more user PCs 31 adapted to implement the send document agent application 32 of the present invention. A PC user 28 is connected to and interacts with the send document agent application. Note that the user PCs, authentication server and recipient PC may comprise any type of computing device such as PC, laptop, notebook, palmtop, PDA, microcomputer, minicomputer, wired or wireless device, etc. without departing from the scope of the invention. Further, the mobile device may comprise any computing device with the ability to connect to a mobile wireless network, e.g., PDA, Blackberry type device, Treo type device, etc. Internet access to the mobile devices is provided via the gateway 35 which connects the mobile wireless network 36 to the Internet cloud 33. The user PC, recipient PC and authentication server may reside anywhere in the network 25.

The send document agent (SDA) 32 resides on the user PC (i.e. the computer with the documents to be forwarded to the recipient; hereinafter referred to as the “user PC”). The mobile client (MC) runs on the mobile computing device (hereinafter the “mobile device,” “mobile client” or MC). The mobile client may be construed as any software, hardware or combination of software and hardware, capable of communicating with the user PC which includes, but is not limited to, a conventional web browser, a custom application or any other software that can access HTML and render such to the end user. The MC may or may not employ a middleware application. The mobile device can comprise any type of processing device such as a desktop PC, laptop PC, notebook, palmtop, PDA, cellular telephone with web access, etc., and is not critical to the operation of the invention.

The document interaction application of the present invention provides a user with the capability of initiating on a mobile device the sending of messages with or without attachments to recipient PCs from a user PC. Note that in the example network presented herein, the manner in which the send document agent application communicates with the recipient PCs, authentication server and mobile devices is not critical to the invention.

A mobile user is provided with complete access to the content on their PC (e.g., audio, video, files, application data, etc.) through the SDA that resides on the user PC (assuming the agent is configured a priori to do this). The SDA converts (i.e. translates or renders) files and resources to be delivered as an RSS document which can be further “stylized” through HTML style sheets (like XSTL) and delivered to anything capable of consuming web pages, such as for example, an ordinary Internet browser like Microsoft Internet Explorer or a specialized reader.

The invention also comprises a relay mechanism whereby the location of the SDA/user PC on the Internet does not need to be known by the MC. User PCs register their locations with a third party authentication server located anywhere on the Internet. The MC requests from the authentication server the location of a user PC using a unique serial number assigned to and used to uniquely identify each user PC.

Once the location of the user PC is known, a peer-to-peer connection with the SDA/user PC is created. Via the peer-to-peer relationship the user PC and MC communicate directly with each other rather than through a third party intermediary for translation or processing.

Note that in this example, the manner of how the MC communicates with the user PC is not critical to the invention. For illustrative purposes only, the mobile user may use a wireless PDA or a cellular telephone wherein each connects to the Internet through the wireless network 36. The PC is shown connected directly to the Internet. It is appreciated, however, that a laptop equipped with a wireless card can communicate over the wireless network 36 as well.

### Computer Processing System

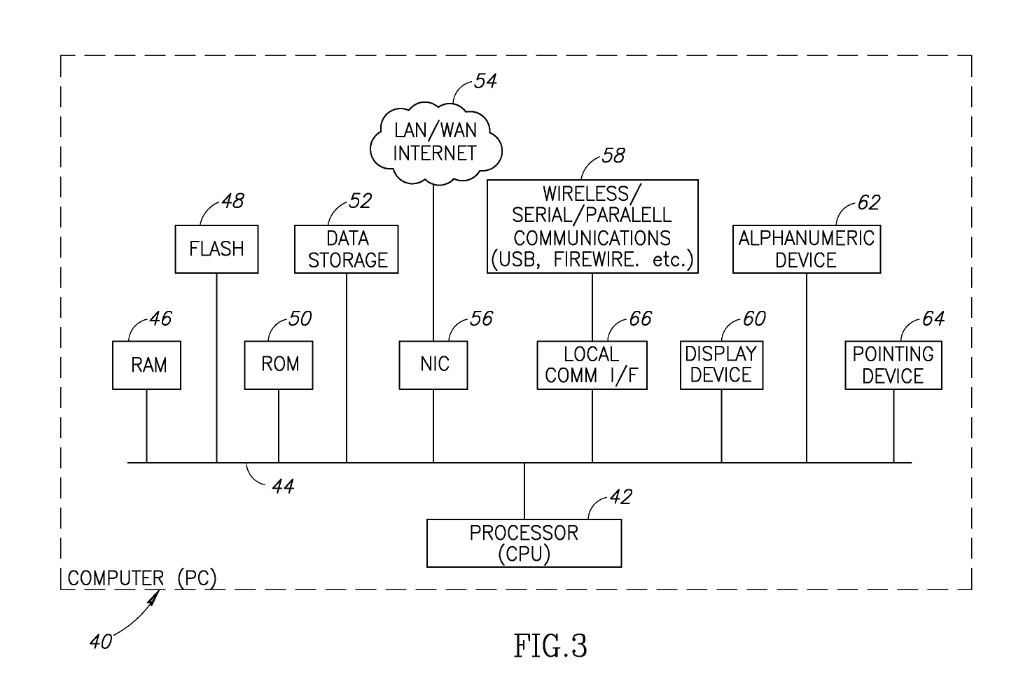

A block diagram illustrating an example computer processing system architecture suitable for use with the present invention is shown in FIG. 3. The computer system, generally referenced 40, comprises a processor 42 which may comprise a digital signal processor (DSP), central processing unit (CPU), microcontroller, microprocessor, microcomputer, ASIC or FPGA core. The system also comprises static read only memory 50 and dynamic main memory 46 all in communication with the processor. The processor is also in communication, via bus 44, with a number of peripheral devices that are also included in the computer system. Peripheral devices coupled to the bus include a display device 60 (e.g., monitor), alpha-numeric input device 62 (e.g., keyboard) and pointing device 64 (e.g., mouse, tablet, etc.)

The computer system is connected to one or more external networks such as a LAN or WAN 54 via communication lines connected to the system via a network interface card (NIC). A local communications I/F port(s) 66 provides connections to various wireless and wired links and serial and parallel devices. Examples include peripherals (e.g., printers, scanners, etc.), wireless links (e.g., Bluetooth, UWB, WiMedia, WiMAX, etc.) and wired links (e.g., USB, Firewire, etc.) The network adapters 56 and local communications I/F port(s) 66 coupled to the system enable the data processing system to become coupled to other data processing systems or remote printers or storage devices through intervening private or public networks. Modems, cable modem and Ethernet cards are just a few of the currently available types of network adapters.

The system also comprises magnetic or semiconductor based storage device 52 (e.g., RAM) for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the document interaction mechanism is adapted to reside on a computer readable medium, such as a magnetic disk within a disk drive unit. Alternatively, the computer readable medium may comprise a floppy disk, removable hard disk, Flash memory 46, EEROM based memory, bubble memory storage, ROM storage, distribution media, intermediate storage media, execution memory of a computer, and any other medium or device capable of storing for later reading by a computer a computer program implementing the system and methods of this invention. The software adapted to implement the document interaction mechanism of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the document interaction mechanism of the present invention, and to the extent that a particular system configuration is capable of implementing the system and methods of this invention, it is equivalent to the representative digital computer system of FIG. 3 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk, semiconductor memory (USB flash, etc.) or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

### Mobile Device/Cellular Phone/PDA System

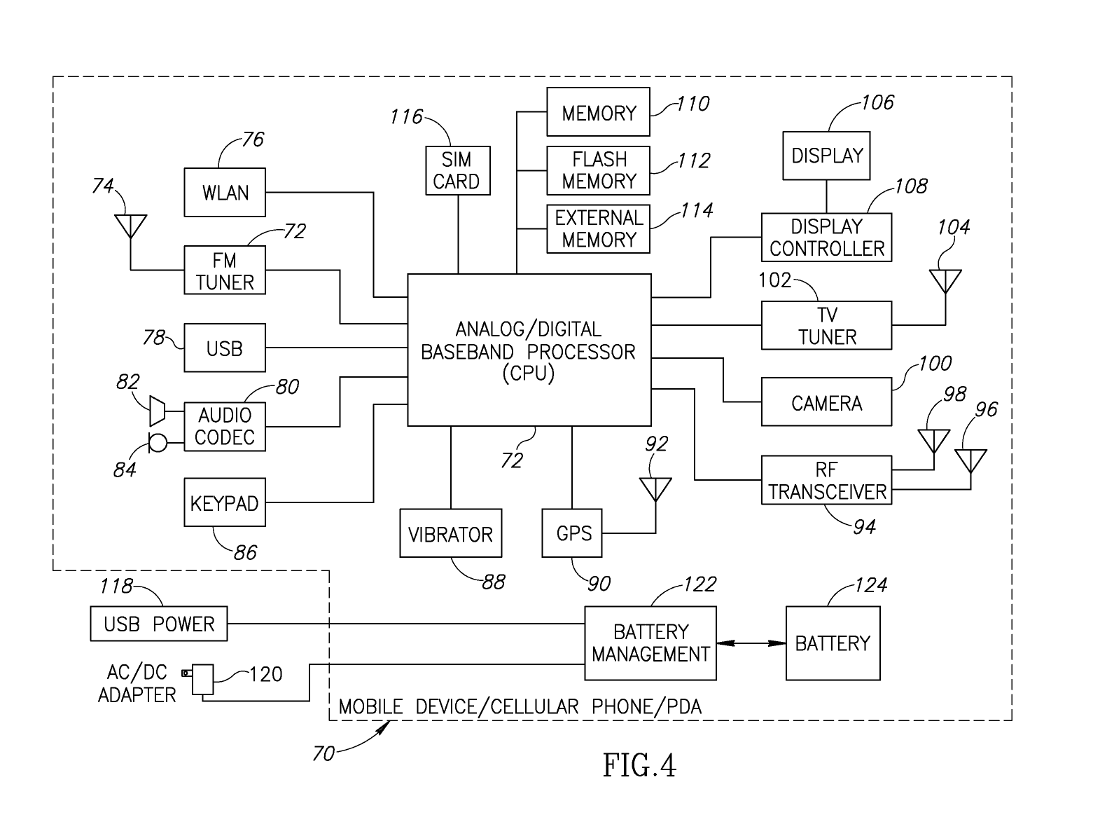

A block diagram illustrating an example mobile device/cellular phone/PDA system architecture suitable for use with the present invention is shown in FIG. 4. The mobile device/cellular phone/PDA (hereinafter the “cell phone”), generally referenced 70, comprises a baseband processor or CPU 72 having analog and digital portions. The basic cellular link is provided by the RF transceiver 94 and related one or more antennas 96, 98. A plurality of antennas is used to provide antenna diversity which yields improved radio performance. The cell phone also comprises internal RAM and ROM memory 110, Flash memory 112 and external memory 114.

Several user interface devices include microphone 84, speaker 82 and associated audio codec 80, a keypad for entering dialing digits 86, vibrator 88 for alerting a user, camera and related circuitry 100, a TV tuner 102 and associated antenna 104, display 106 and associated display controller 108 and GPS receiver and associated antenna 92.

A USB interface connection 78 provides a serial link to a user's PC or other device. An FM tuner 72 and antenna 74 provide the user the ability to listen to FM broadcasts. WLAN interface 76 provides wireless connectivity when in a hot spot or within the range of an ad hoc, infrastructure or mesh based wireless network. SIM card 116 provides the interface to a user's SIM card for storing user data such as address book entries, etc.

Portable power is provided by the battery 124 coupled to battery management circuitry 122. External power is provided via USB power 118 or an AC/DC adapter 120 connected to the battery management circuitry which is operative to manage the charging and discharging of the battery 124.

### Authentication Server

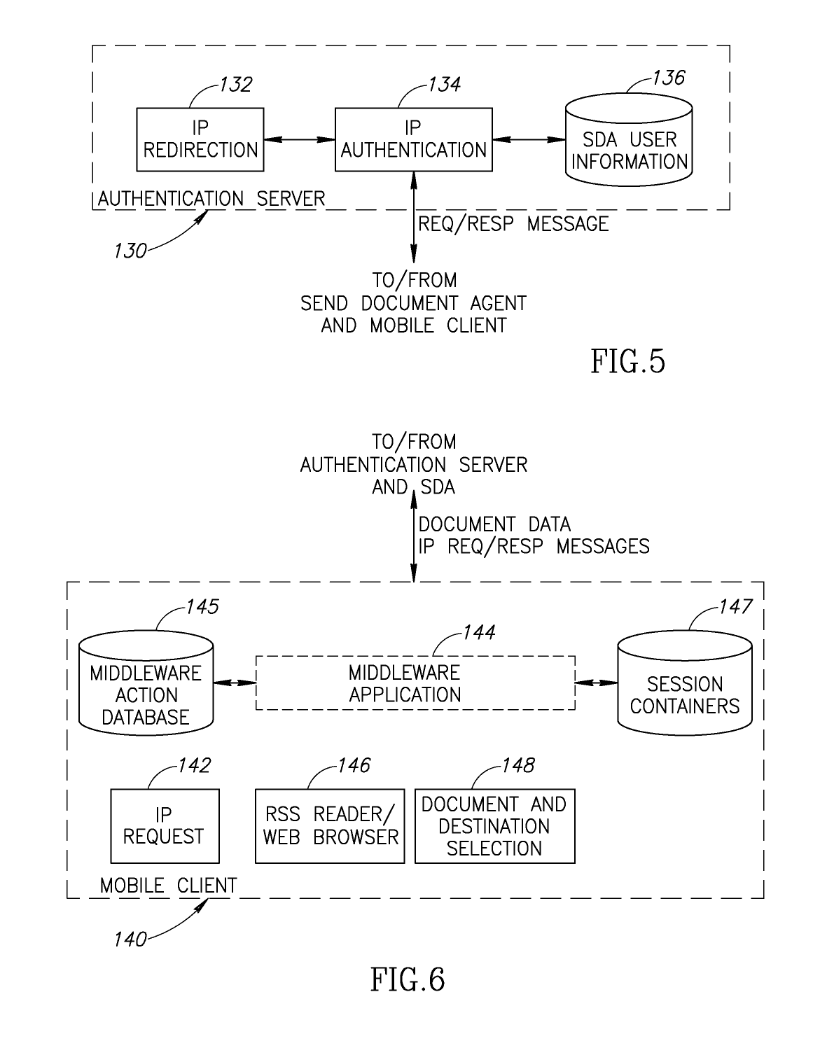

A block diagram illustrating the authentication server of the present invention in more detail is shown in FIG. 5. The authentication server, generally referenced 130, comprises an IP redirection module 132, IP authentication module 134 and SDA user information database 136. The authentication service is a third party service provided by a remote server that can reside anywhere on the Internet. Its purpose is to relay the location of user PCs (SDAs) to requesting mobile clients. The operation of the various components of the authentication server will now be described in more detail.

The SDA user information database 136 functions to store the WAN IP address of the SDA or user PC for communication to the mobile device to facilitate the peer-to-peer connection. The SDA user information database comprises the following fields:
1. Serial number representing the unique serial number of the Send Document Agent (SDA);
2. WAN IP address comprising the Wan IP address of the computer on which the Agent resides;
3. Port number: the port number on which the SDA is listening;
4. Username is the username of the PC user authenticated to modify the record of the WAN IP address (this is supplied by the user during the initial setup of the SDA);
5. Password is the password of the PC user authenticated to modify the record of the WAN IP Address

In operation, each user PC via its SDA communicates (i.e. registers) its WAN IP address to the IP authentication server before any document interaction occurs. The transfer of the IP address and related server information is encrypted at the user PC before transmission utilizing a standard encryption methodology (e.g., public/private key, RSA, MD5, Blowfish, etc.) wherein the unique serial number of the SDA is used as the primary encryption key. The user PC transmits this message to the authentication server by way of HTTPS (SSL secured HTTP communication). The authentication server listens for transmission traffic on a specific IP address and port number. When a user PC attempts to deliver data to that IP address and/or port number, it first sends its serial number in a hash sequence to the authentication server which decrypts the information to reveal the serial number. Note that only an authentication server with the correct hash key can decrypt the unique serial number within the hash that was encrypted using the same key by the user PC. Note also that the serial number is generated through a random process by the enterprise or company that owns the user PC and is provided to authorized mobile users.

Once the serial number has been verified after being decrypted, the authentication server creates a unique “connection key” that is transmitted to the user PC. This key is then appended to each and every transmission between the user PC and the authentication server during the transaction of sending data from the user PC to the authentication server. Any communication that does not have a key appended to it will not be recognized by the authentication server. The data from the user PC is then sent in encrypted text to the authentication server which decrypts the message from the user PC and verifies it against a record in the SDA user information database using the MAC address as the primary key. If no record is found, a unique serial number is generated corresponding to the user PC. A new record is created in the user information database and the serial number along with the IP address, MAC address and port number of the user PC are stored therein. The record stored in the authentication server user information database comprises the IP address, MAC address and port number of the SDA on the user PC.

If the user PC sending the message is already registered and the user PC is verified to be authentic, the IP authentication module updates the record in the SDA user information database corresponding to the MAC address in the message with the current WAN IP address of the user PC. In this manner, the authentication server is kept up to date when the user PC changes location.

When a MC requests the location of a user PC, it sends a request to the authentication server. The request includes the unique serial number previously assigned to the user PC. The SDA user information database is searched for a matching user PC record using the serial number as the key. If a matching user PC record is found and if the received request is from a browser, the IP redirection module is operative to HTTP redirect the browser to the IP address on record for the user PC in the request. The redirection can be accomplished through a simple web based form into which the user enters the unique serial number corresponding to the user PC, a username, and one or more credentials. The IP redirection module retrieves the WAN IP address and port number from the SDA user configuration database and passes the web browser request to the requesting mobile user which then redirects to that IP address, passing the encrypted username and password encrypted with the serial number of the user PC to the user PC where it is decrypted using the user PC serial number. Once decrypted, a unique session is created that is shared between the user PC and the MC or conventional web browser for the transmission session.

### Mobile Client (MC)

A block diagram illustrating the mobile client (MC) of the present invention in more detail is shown in FIG. 6. The mobile client (MC), generally referenced 140, comprises an IP request module 142, RSS reader 146, optional middleware application 144, document/destination selection block 148, middleware action database 145 and session containers 147. It is important to note that the MC can reside on any suitable computing device and is not limited to mobile or cellular devices. For example, the MC can reside on cellular phones, mobile devices, PDAs, desktop PCs, laptop PCs, palmtop devices, or any other wired or wireless computing device. In accordance with the invention, it is not critical that the MC comprise a unique software application. Alternatively, the MC may comprise a conventional web browser that is capable of transmitting, receiving and rendering HTML.

he middleware action database (if it resides on the mobile device) has the following database fields:
1. CodeID: is the code that the middleware looks for on the URL;
2. Variable: a variable to look for associated with a CodeID
3. Action: an action to carry out (this may be code stored in the database) against a variable

Once the variables have been retrieved, the middleware application then stores the variables in appropriate session containers as identified by the rule set retrieved from the middleware action database. Session containers are typically used in ‘server-side programming’ and refer to temporary holders of values received from web-based applications

Note that the middleware application is operative to not only handle retrieval of data from the user PC, performing actions on that data but also to interact with other features of the cell phone or mobile device such as capturing wireless network related data from the base station and sending this data to the SDA on the user PC.

The RSS reader/web browser is a software application that runs on the mobile client for processing and displaying (i.e. rendering) RSS documents (e.g., RSS 2.0 documents) served by the SDA on the user PC to the MC via the network. The RSS reader also provides connectivity to the SDA and authentication server. The RSS reader application provides basic functionality, such as search, browse, select, etc., that allows the user to interact with the RSS document and retrieve document and recipient information from the user PC via the SDA. This is accomplished when the user clicks on an item within selection lists displayed by the MC on the mobile device. After a user selects an item from a first RSS document, they can select an item from a second RSS document. This application records these two selections and presents them as a confirmation to the user PC.

When the RSS reader first establishes a connection directly with the SDA, the reader sends credentials which are validated and authenticated by the SDA agent on the user PC. The credentials comprise username, password and serial number of the SDA.

The IP request module is operative to initiate a connection to the authentication server by sending a request to the authentication server for the IP Address of the user PC it wants to connect to. The request comprises the unique serial number and/or MAC address associated with the user PC. The authentication server, via the IP authentication module, is operative to authenticate the message and retrieve the WAN IP address and port number of the SDA/user PC corresponding to the serial number included with the request. The IP address and port number are then sent to the MC whereby the RSS reader configures and creates a direct connection with the desired user PC using the WAN IP address and port number.

The document/recipient selection block functions to handle the selection process of the items within the two RSS documents and the presentation of the confirmation screen. The selection process allows a mobile user to select zero or more documents (a message may be sent without an attachment) and one or more recipients from lists served by the SDA on the user PC. The block also handles edits and other changes to items made by the mobile user as part of the selection process before sending the selection to the SDA. Once a selection is confirmed, the block sends the final selections back to the SDA on the user PC for interpretation. This block also handles direct transmission of data between the mobile device and the user PC.

The optional middleware application resides on the mobile device but has no GUI of its own. If employed by a mobile client, it functions as an “intermediary” between the SDA and the RSS reader/mobile web browser. It has two primary functions as described below.

The first function is to monitor all traffic from the RSS reader/mobile web browser. All traffic received is scanned for special codes (as stored in the middleware action database). If a special code is detected, the associated traffic is intercepted by the middleware and acted upon in accordance with the contents of the middleware action database.

The second function is to receive data from the SDA and in the form of XML, HTML or other standard data-representation mechanism, transform it using a set of rules and an “engine” (i.e. code specifically designed to parse data and compartmentalize it according to a set of rules) into HTML (i.e. WAP 2.0 standard) and present it to the mobile browser for display to the mobile user. An application command is sent, such as via the mobile operating system, to the mobile browser with a parameter of the URI pointing to the physical HTML file on the mobile device or the URL of the webpage as it resides on the user's PC and served through the SDA.

The application forward module functions to forward the RSS document sent by the MMS to the particular application(s) 168 that is designated to handle that type of document on the client computing device. In the case a document type is received wherein the supporting application is not known, the user can be queried for the application to open the file with.

### Send Data Agent/User PC

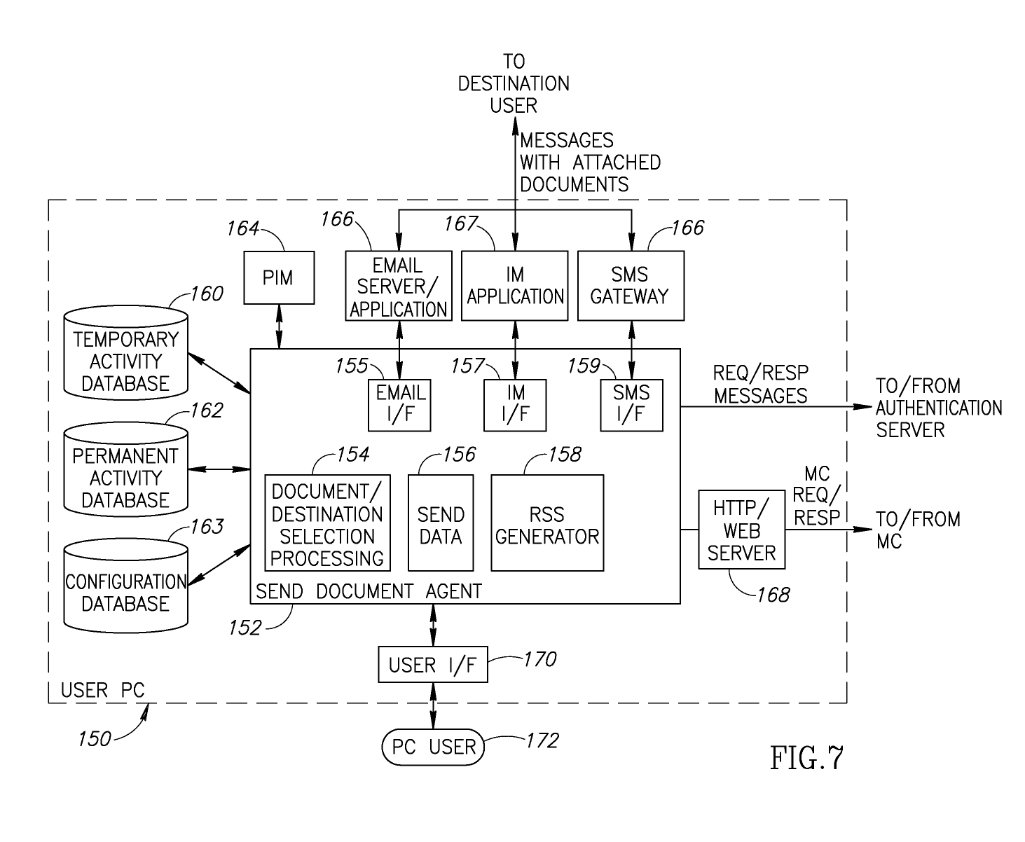

A block diagram illustrating the user PC and the send document agent of the present invention in more detail is shown in FIG. 7. The user PC, generally referenced 150, comprises a send data agent (SDA) 152, temporary activity database 160, permanent activity database 162, configuration database 163, PIM 164, email server/application 166, IM application 167, Short Message Service (SMS) gateway 169, HTTP/web server 168 and user interface (I/F) 170. The SDA comprises a document/destination selection processing block 154, send data block 156, RSS generator block 158, email interface 155, IM interface 157 and SMS interface 159. The RSS generator block is adapted to render files and resources in RSS format and to “translate” or “style” the RSS, a subset of XML, through eXtensible Style Sheet (XSTL) into HTML. The HTML is then consumed by any application capable of rendering HTML content, such as a conventional web browser. This mechanism allows “serialized content” such as RSS to be embedded into an otherwise normal looking webpage and not a list of RSS data elements.

The primary function of the RSS agent is permit the PC user to create a list of documents she/he would like to share. These documents are converted into RSS format. Alternatively, the SDA can monitor the “My Documents” folder (and subfolders thereof) for documents to convert. The SDA also functions to synchronize contacts in the user's primary PIM (e.g., Microsoft Outlook, etc.) with an RSS document representing these contacts. The contacts actually represent potential recipients of messages and documents. Further, the SDA also functions to serve up both RSS documents (i.e. the document list and contact/recipient list) in response to an appropriate request from the mobile device.

The SDA also functions to provide the connectivity between the user PC and the reader in the MC and to handle requests for documents received from the MC. The SDA also provides the user interface to the PC user. For example, management functions provided by the SDA include: (1) checking for authorized access to both the user PC and the RSS documents via username and password as well as (2) emailing credentials to mobile users when the credentials are created.

The SDA also functions to monitor the NIC through which the connection to the MC is made. Any changes detected in the WAN IP address assigned to the NIC are relayed to the authentication server. If a change is detected, the SDA is operative to send a change message to the authentication server comprising the WAN IP address, MAC address of the NIC card and port number of the user PC.

The HTTP server module 168 of the user PC provides the capability to the PC user for web-based viewing/streaming of PC content through a conventional Internet web browser.

The SDA has access to the PC hard disk contents (not shown) and also interfaces with one or more applications (e.g., PIM, email server, IM gateway, SMS gateway). The applications have access to the hard disk contents and their associated application data which may be stored on the hard disk or separately.

The SDA comprises two activity databases: a temporary activity database 160 adapted to store session-based information as the user is constructing a message to send and a permanent activity database 162 that serves to capture activities actually performed, logs, etc.

Records in the temporary activity database are created by the SDA each time a mobile user employs the document interaction mechanism to send messages and documents to recipients. The temporary activity database comprises the following fields:
1. Time: indicates the time that the process was initiated (taken from the system clock on the PC);
2. Date: indicates the date that the process was initiated (taken from the system clock on the PC);
3. Document: indicates the URI to one or more documents located on the user's PC;
4. Email Addresses: contains one or more email addresses either culled from the RSS index of the user's contacts or manually input by the user;
5. Email Message: contains the ID of the standard email message (as it is stored in a separate database) or the text of a message manually entered by the mobile user through their mobile device;

The permanent activity database comprises all the fields of the temporary activity with the addition of the following fields:
1. Success: a Boolean flag (0 or 1) that indicates whether the message was sent successfully or not, with a ‘0’ indicating failure and ‘1’ indicating success;
2. Failure: contains an error code generated by the SDA in the event the message transmission was not successful (i.e. Success flag=0);

In addition to the temporary and permanent activities database, the SDA also comprises a configuration database 163 adapted to store information about how the SDA should operate, users authenticated to access the system, etc. This database comprises the following fields and may be related to minor databases that, together, all comprise “configuration data”:
1. Username: contains a username that is authenticated to access the system;
2. Password: contains a password that corresponds to a username that is authenticated to use the system;
3. Messages: contains canned messages the user has entered before and elected to save;

### Processing Sequence

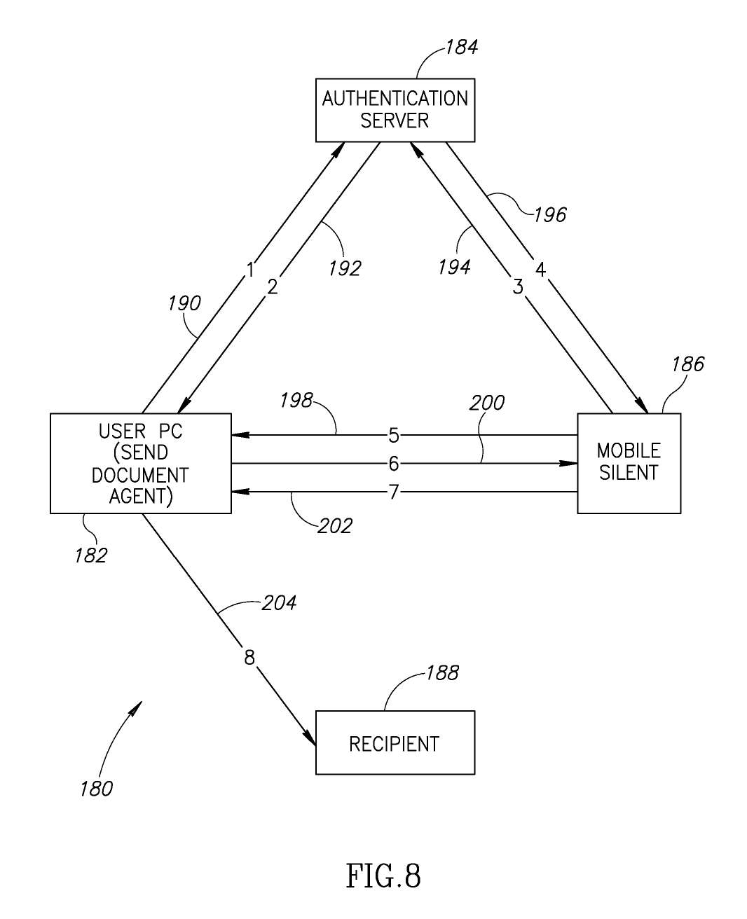

A block diagram illustrating the processing sequence of the RSS based document interaction mechanism of the present invention is shown in FIG. 8. The example configuration, generally referenced 180, comprises the authentication server 184, user PC (with SDA) 182, mobile client 186 and recipient 188, each in communication with each other. The processing sequence is indicated by the arrows numbered 1 (referenced 190), 2 (referenced 192), 3 (referenced 194), 4 (referenced 196), 5 (referenced 198), 6 (referenced 200), 7 (referenced 202) and 8 (referenced 204).

With reference to FIGS. 5, 6 and 7, the following provides a description of the processing sequence representing the high level flow of the operation of the document interaction mechanism of the present invention.

Processing Sequence Step 1 (referenced 190):

The SDA application on the user's PC communicates its WAN IP address (e.g., the IP address assigned to it by an ISP) to the third party service on the remote authentication server. As described supra, the WAN IP address is sent along with the MAC address of the network interface card (NIC) as well as the port number of the user PC that the application will use to listen for incoming requests from MCs. The data is encrypted using a standard encryption algorithm and incorporated in a message sent to the authentication server. The authentication server functions to decrypt the message and, using the MAC address as a key, updates a corresponding record in the SDA user information database with the new WAN IP address if a record corresponding to that user PC already exists.

Processing Sequence Step 2 (referenced 192):

If a record is not in the SDA user information database, the authentication server generates a unique serial number to be associated with the user PC. The authentication server sends the serial number back to the user PC. The user PC stores the serial number for use in authenticating requests from the MC for RSS documents. Ultimately, the mobile user at the MC must provide the appropriate serial number corresponding to the user PC desired to receive content from.

Processing Sequence Step 3 (referenced 194):

When initiated by a mobile user, the MC in the client computing device contacts the third-party service running on the authentication server using the unique serial number corresponding to the SDA on the user's PC. Note that the serial number and other information were entered into the MC upon first use along with the username and password of the user PC. In the event that the MC is a conventional web browser, such credentials can be stored in a medium on the user's hard drive (such as a “cookie”) and transmitted to the user PC for authentication. The authentication server attempts to authenticate and verify the received information.

Processing Sequence Step 4 (referenced 196):

If the authentication server finds a match and successfully resolves the serial number sent by the MC, it retrieves the corresponding record from the SDA user information database which comprises the IP address and port number of the user PC associated with that serial number. The IP address and port number is sent back to the MC.

Processing Sequence Step 5 (referenced 198):

Having obtained the location of the SDA/user PC, the MC connects to user PC via the Internet using the IP address and port number received from the authentication server. This creates a “peer-to-peer” relationship in which requests sent by the MC are sent directly to the user PC and not to a third-party or intermediary for translation or processing. The MC sends the username and password that was entered upon first use along with the serial number associated with that user PC. The SDA on the user's PC resolves, verifies and authenticates the credentials.

Processing Sequence Step 6 (referenced 200):

Once connectivity between the mobile device and the SDA has been established, the SDA transmits to the MC RSS documents for selection by the mobile user. The RSS documents are transformed through XSLT into a presentable and readable format in HTML. Preferably, the SDA and MC provide the RSS document lists in the form of a software ‘wizard’ where the user is guided through a sequence of steps. The user first selects a document from the list of documents. The mobile user is also provided a means for searching for a document.

In addition, the mobile user is presented with a list of recipients. The email addresses that represent the user's contacts are displayed as the possible recipients of the documents just selected. The user selects one or more emails from the list of recipients.

The mobile user is also offered an opportunity to enter a message or select from a list of ‘canned’ messages which are created through the SDA on the user PC.

Processing Sequence Step 7 (referenced 202):

Once the mobile user ‘clicks’ on a document, the selection of that document is transmitted to the agent. Once the email addresses have been selected, the mobile user is presented with the documents to send and the email addresses to which they will be sent. After the mobile user clicks ‘submit’, the data including document selections, email addresses and message is sent from the MC to the SDA either through the middleware application or directly via a peer-to-peer connection.

Processing Sequence Step 8 (referenced 204):

Upon receipt of the document, email and message data from the MC, the SDA forwards the data to the appropriate application, e.g., PIM, email, IM gateway, SMS gateway, etc. After the message is sent, the SDA sends an acknowledgement (confirmation message) to the MC through the same web pages or through the middleware application that in turn presents the mobile user via HTML in the mobile browser with the confirmation message. In the event the mobile user has elected to send a message to a contact format other then an email address, the message is steered to the appropriate application. If the elected contact method is a mobile phone number, the SDA sends the SMS message to the selected carrier for processing via the SMS interface. If the elected contact method is an Instant Message (IM) address, the SDA utilizes an integrated IM client to send the message to the IM system.

Note that the invention utilizes the really simple syndication (RSS) format to send document and email related information between the SDA and the mobile device. Every object that can be identified through a Uniform Resource Identifier (URI) or Uniform Resource Locator (URL) is a resource that can be embedded in an RSS document. An RSS document contains information about which information objects are to be found under a URI or URL. In addition, it can include a description of the resource and the individual information objects, the specification of a unique identifier for the objects and other information. It is also possible that the information object described may be completely embedded in the feed document.

All RSS documents are translated into serialized strings of characters and they use existing formats for content, i.e. simple text, HTML, XHTML, other XML vocabularies. RSS works independently of the internal structure of the information. Any item or collection of information can be the object of a RSS document. There are two kinds of information objects in all RSS formats, that is, collections of new information items and new individual items of information. The collections are called a channel (or a feed); an object within a collection is called an item or an entry. Both the channel and the item comprise content information, metadata, and information about the identification and linking of information objects.

An RSS document may describe another web resource, namely, the resource that is identified by the content of the link element. The presence of an element called a link, and with it, the ability to identify a document it refers to, distinguishes RSS documents from other web formats like HTML. The link element only states what the RSS document describes.

One of the characteristics of RSS is that the description is defined very generically making it is possible to include any type of content in the description. Thus, any kind of web content can be sampled and further distributed in an RSS document.

In addition, RSS, as a subset of XML, can be “translated” and “stylized” through eXtensible Style Sheet (XSTL) into HTML and thereby consumed by any application capable of rendering HTML content, such as a conventional web browser. This mechanism allows “serialized content” such as RSS to be embedded into an otherwise normal looking webpage and not a list of RSS data elements.

### Send Document Method

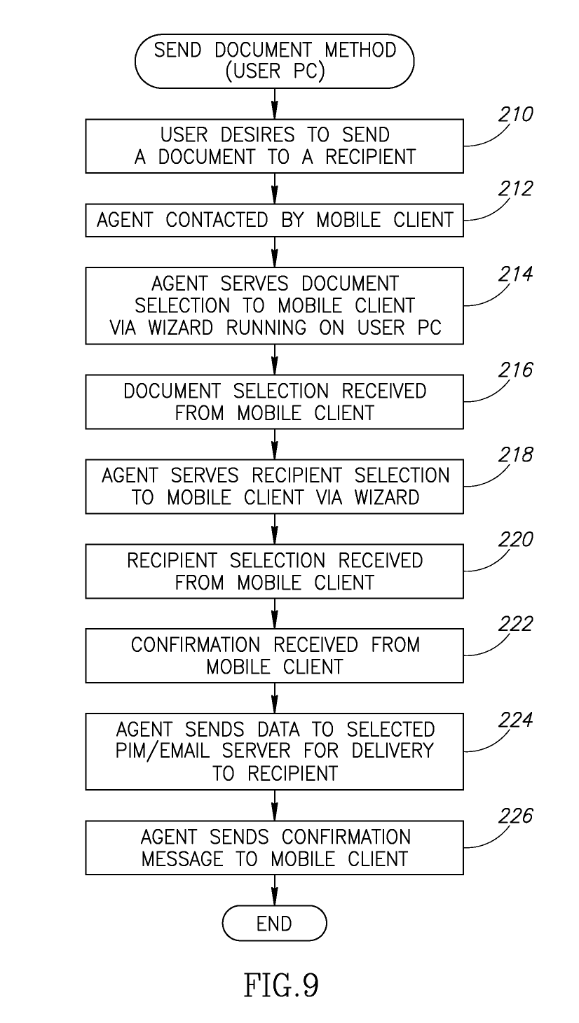

A flow diagram illustrating the user PC based send document method of the present invention is shown in FIG. 9. Initially, the mobile user desires to send a document to a recipient (step 210). It is important to note that messages generated and sent by the mechanism of the present invention may or may not have attachments (i.e. documents). Further, messages may be sent to any number of one or more recipients.

The SDA is then contacted by the mobile client (step 212). Once authenticated, the SDA serves an RSS formatted document selection list to the mobile client via an optional wizard running on the user PC (step 214). The mobile user selects a document from the list of documents and the selection of the document is received by the SDA from the mobile client (step 216). The SDA either transmits the page that corresponds to the next page of the process or the SDA simply transmits information (such as XML data) which the middleware application on the MC can transform and present to the mobile user through the mobile browser.

The SDA then serves an RSS formatted email (recipient) selection list to the mobile client via the optional wizard (step 218). Note that the list presented to the mobile user may comprise any suitable representation of recipients depending on the preference of the PC user and mobile user. Recipients/contacts may be represented, for example, by email addresses, IM addresses, SMS recipients, or any other suitable messaging technology.

The mobile user selects one or more recipients from the recipient list selection and the selection is received by the SDA from the mobile client (step 220). Confirmation is received, along with the message, any documents and one or more recipients from the mobile client indicating that the selections made by the mobile user are final (step 222). The SDA then assembles the message directed to the appropriate recipients and sends it with any attachments to the appropriate server or gateway depending on the preference of the PC user and mobile user for delivery to the one or more recipients (step 224). If the message is to be sent via email, the message is forwarded to the email server/application 166 via the email interface 155. If the message is to be sent via IM, the message is forwarded to the IM application 167 via the IM interface 157. If the message is to be sent via SMS, the message is forwarded to the SMS gateway 169 via the SMS interface 159.

Once the message has been successfully sent, the SDA generates and sends an acknowledgement (or confirmation) message to the mobile client (step 226).

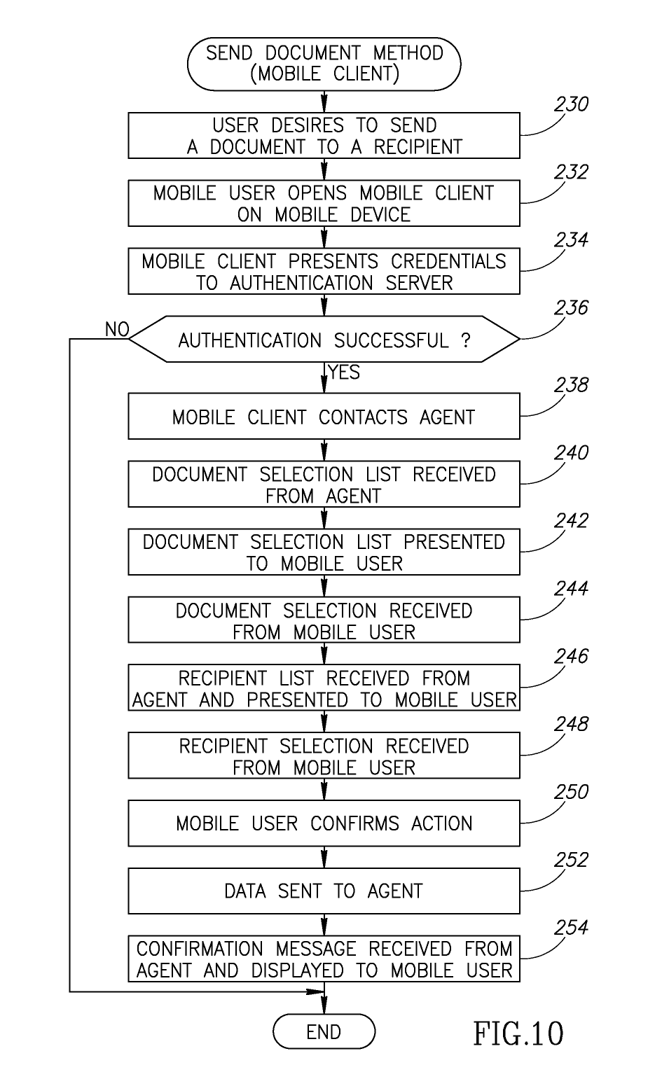

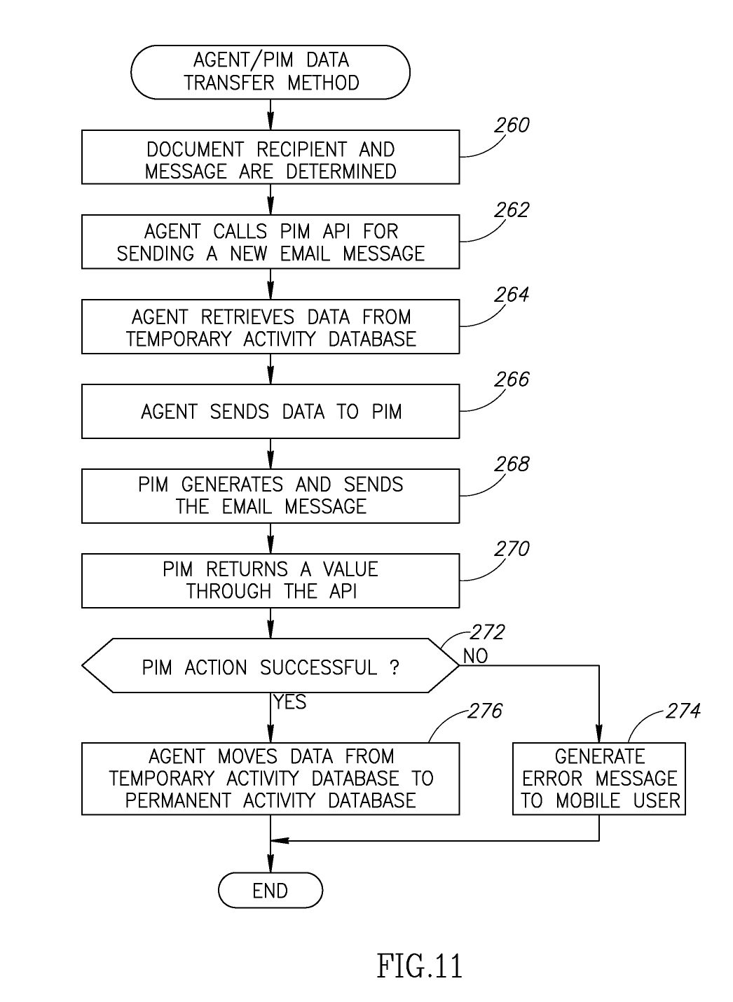

A flow diagram illustrating the mobile client based send document method of the present invention is shown in FIG. 10. Initially, the mobile user desires to send a message and zero or more documents to one or more recipients (step 230). The mobile user opens the mobile client on the mobile device (step 232). The mobile client presents credentials (i.e. serial number, password, etc.) to the authentication server (step 234). If authentication is successful (step 236), the mobile client contact the SDA (step 238). The mobile client receives the document selection list from the SDA (step 240). Note that the SDA does not necessarily simply present the mobile user with the RSS documents. Rather, it optionally presents the documents in the form of a ‘wizard’.

The document list is then presented to the mobile user (step 242). The user selects a document from the list of documents (step 244). Mobile users can also, through a form on the page, search for a document as well. The searching function is handled by the SDA and is operative to look through all folders on a user's hard disk drive (HDD) system to locate the specified file. Alternatively, if the user has selected to have the SDA “monitor” all of their HDD files (where “monitor” refers to the representation of the files by the SDA as an RSS index), the SDA will search the RSS index of the files, thereby providing for a faster response time in returning search results. Once the user clicks on a document, the selection of the document is transmitted to the SDA (either through an HTTP request or through the mobile application ‘intermediary’ (i.e. middleware application) and the next step of the process is engaged. In this manner, the SDA transmits either (1) the page that corresponds to the next page of the process or (2) information (such as XML data) which the middleware application on the mobile client transforms and presents to the mobile user through the mobile browser.

Next, the recipient selection list is received from the SDA presented to the mobile user (step 246). The mobile user selects one or more recipients (e.g., email addresses, IM addresses, etc.) by clicking on the list of email addresses, IM addresses, etc. that represent the user's contact's from Microsoft Outlook or other suitable PIM (step 248). Note that a process of converting a list of contacts from a PIM into RSS format suitable for use with the present invention is described in detail in U.S. application Ser. No. 11/458,955, filed Jul. 20, 2006, entitled “System And Method For Delivery Of PC Content Through A Server Based Relay System Using Really Simple Syndication,” incorporated herein by reference in its entirety.

As described in U.S. application Ser. No. 11/458,955, a master dataset of applications is used to store a unique ID for each application to be accessed. Since the mechanism of the present invention comprises creating and representing an index of recipient addresses (e.g., email, IM, SMS, etc.), the master dataset could be represented as the following RSS embodiment:

<item>

<title>Name of Contact</title>

<description>Blank</description>

<contactmethod>Email Address or other contact mechanism</contactmethod>

<enclosure/>{application ID}:{element ID}</enclosure>

</item>

Note that the ContactMethod can be repeated for however many contact methods there are for a given contact.

Alternatively, the one or more recipients can be entered through an HTML based form served by the SDA to the mobile user via the web browser. For each recipient (e.g., email address) that the mobile user elects to enter manually, there are a variety of methods by which the recipient selections can be presented to the mobile user for review.

A first method is to present the selections using JavaScript. Each recipient information (e.g., email address) could be collected into a Javascript array and presented to the mobile user in the same HTML document they use to enter recipient information.

A second method is to present the selections using the mobile middleware application, if employed. Assuming middleware is used on the mobile device, acting as an ‘intermediary,’ the HTML form into which the user enters recipient information sends the data entered to the middleware (acting as a web server) which fills a session container 147 (FIG. 6) on the web page with the recipient information for review by the mobile user.

Once recipients have been selected, the mobile user is presented with the zero or more documents to send and the recipient addresses to which they will be sent. At this time, the user enters a message in a final form field or selects from ‘canned’ messages (e.g., “attached is the document you requested”) which are created through the SDA on the user's PC.

The mobile user then confirms the action by clicking ‘submit’ (step 250). The data, which comprises the document selection (a URI pointer to the file on the user's PC), recipient addresses and message (text in an XML container), is sent to the SDA on the user's PC (step 252). The data is sent either via the middleware application or directly via a peer-to-peer connection. The SDA then carries out the process by sending the data to the selected recipients via the appropriate message technology (e.g., email, IM, SMS, etc.). When the message has been sent successfully, the mobile client received an acknowledgement message from the SDA which is displayed to the mobile user (step 254).

Note that any well known techniques of (1) generating a list of documents from a hard drive memory and (2) delivery of RSS documents to a mobile user may be used with the present invention, such as described in detail in U.S. application Ser. No. 11/458,955, cited supra.

### Processing of Completed Activity

A flow diagram illustrating the agent/PIM data transfer method of the present invention is shown in FIG. 11. Once the mobile user has completed the actions of (1) identifying zero or more documents; (2) identifying recipients; and (3) identifying the message, the SDA should have all of the above data either from (a) processing it directly as the mobile user interacts with the web pages that are served by the SDA or from (b) the middleware application that sent it all as a single package once the mobile user enters the ‘submit’ or other confirmation indicating button (step 260). The SDA then performs the following tasks in sending the message to the selected recipients.

Assuming the message is to be sent as an email message, the SDA first makes a call to the application programming interface (API) of the PIM for sending a new email message (step 262). The SDA then retrieves the appropriate information from the temporary activity database (step 264). The SDA then sends the retrieved data to the API of the PIM (step 266). Note that usually the data is sent to the API in the form of calling the application's executable file along with command-line parameters associated with a specific API. For example, in the case of sending an email to Microsoft Outlook, an external application might invoke outlook.exe send_email (‘email addresses’, ‘attachments’, ‘message,’ ‘subject,’ etc. Note also that the PIM is used herein for illustration purposes only. In operation, the SDA sends the data to the appropriate application in accordance with the type of recipient (e.g., email, IM, SMS, etc.)

The PIM then carries out sending the actual email message (step 268). Alternatively, in the case of an email recipient, the email server/application sends the actual email message to the Internet. Once the PIM or email server/application has sent the email message, the API returns a value indicating whether the email message was sent successfully or not (step 270). When the API call is executed, the PIM returns a result such as True or False to indicate success or failure, respectively, along with an error code which can be stored by the SDA and also presented to the user in a readable format (e.g., an error code of 33149 transmitted by an application in response to data sent via an API call might be rendered to a user as “failed to send message because Internet connection is closed”).

If the PIM action was successful (step 272), the SDA then moves the message data from the temporary activity database to the permanent activity database as ‘log’ data and removes the corresponding record from the temporary activity database as it is no longer temporary but permanent (step 276). If the PIM action was not successful (step 272), the SDA generates an error message that is sent to the mobile client for display to the mobile user (step 274).

### Recipient Address Selection Method

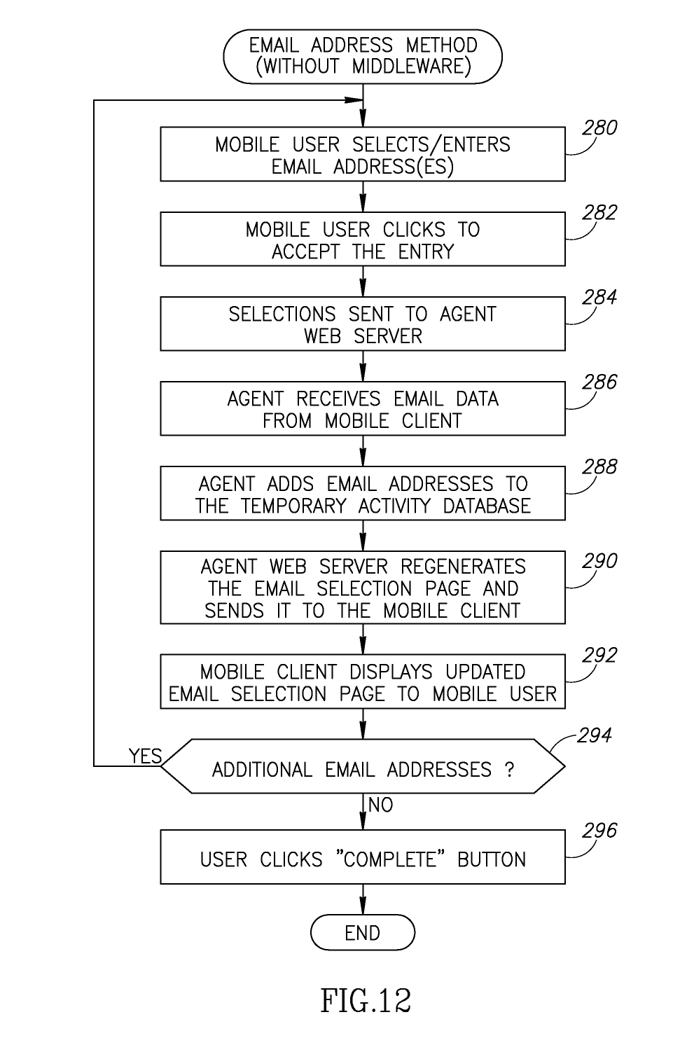

A flow diagram illustrating the recipient address selection method of the present invention with no middleware on the mobile device is shown in FIG. 12. This method of adding recipient addresses is used when there is no middleware application to capture the contents on the mobile device. Note that the following description is provided in the context of recipient addresses comprising email messages. It is appreciated that the method is applicable for any type of recipient address and is not meant to be limited to the email address example presented herein.

The mobile user selects or manually enters email addresses (step 280). Email selection (or any other recipient address) is made by clicking an email address link from the RSS file displayed by the mobile client. Email addresses can also be entered manually by the mobile user through an HTML form. When the mobile user has selected or entered an email address, she/he clicks a button to accept the entry (step 282). Note that in the event of email selection, there is no manual entry and the mobile user simply clicks an associated link.

Because the mobile user is interacting with a webpage that is served by the SDA, all submission of interactivity (i.e. form data, clicking on links, etc.) is handled by the web server integrated with the SDA. The selection data is then sent to the SDA (step 284). Upon receipt of the selected or entered email addresses (step 286), the SDA adds them to the email addresses stored in the temporary activity database associated with the session of activity in which the mobile user is currently engaged (step 288).

The web server 168 (FIG. 7) on the user PC, suitably programmed, then regenerates the email selection page and sends it to the mobile client (step 290). The regenerated email selection page comprises the following:
1. The form to be used by the mobile user to enter another email address;
2. The email address that was just added along with a link to remove it;
3. The list of email addresses from the RSS index of the user's PIM data along with a link for each email address to select it as a recipient;

The regenerated email selection page is received by the mobile client and displayed to the mobile user (step 292). If the mobile user has additional email addresses to add to the recipient list (step 294), the process of adding selections, regenerating and displaying the email selection page is repeated until the user indicates she/he has completed selecting/entering email addresses by clicking the ‘complete,’ ‘submit’ or similar button (step 296).

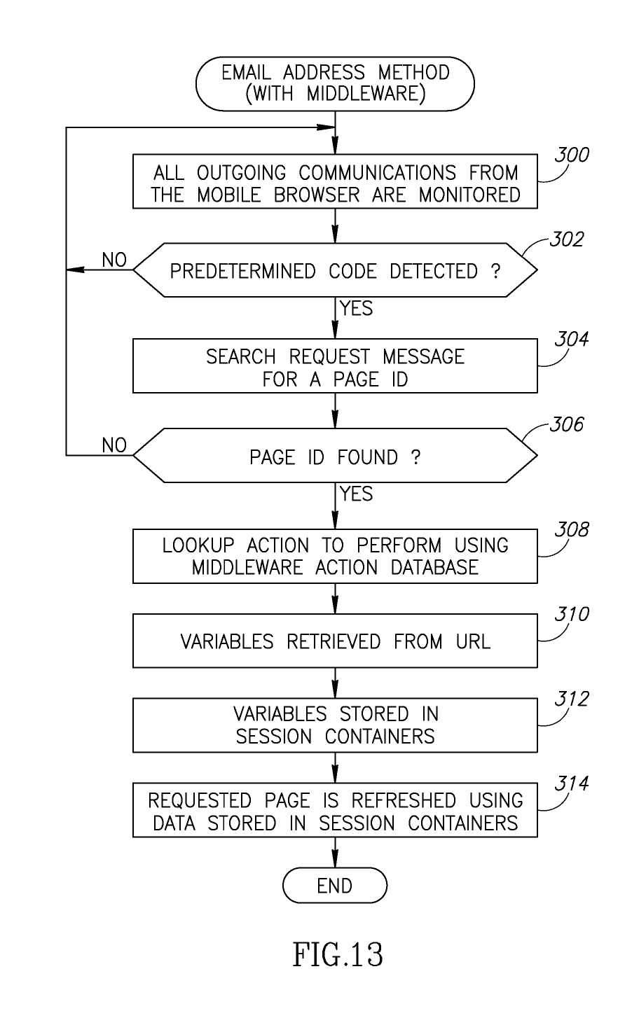

A flow diagram illustrating the email address method of the present invention with middleware on the mobile device is shown in FIG. 13. This method of adding recipient addresses is used when a middleware application is used to monitor (i.e. capture) the contents on the mobile client (step 300). As explained supra, the middleware application monitors all outgoing communication from the web browser. The application examines each request for a particular page ID. In the event the appropriate predetermined code embedded within the URL is located (step 302), the middleware application intercepts the HTTP transmission and searches the request message for a page ID (step 304). If the page ID is found (step 306), a lookup is performed on the middleware action database 145 (FIG. 6) to determine the appropriate action to perform for that page (step 308). The actions stored in the database represent the retrieval of specific variables from the URL (step 310).

Once the variables are retrieved, the middleware application then stores the variables in the appropriate session containers as identified by the rule set retrieved from the middleware action database (step 312). Session containers are normally used in ‘server-side programming’ and refer to temporary holders of values received from web based applications. Finally, the middleware application refreshes the page that the mobile user is requesting, filling the appropriate container on the page with the data that stored in the session containers (step 314).

In alternative embodiments, the methods of the present invention may be applicable to implementations of the invention in integrated circuits, field programmable gate arrays (FPGAs), chip sets or application specific integrated circuits (ASICs), DSP circuits, wired or wireless implementations and other communication system products.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of document interaction between a mobile device and a user computer in communication with each other via one or more communication networks, said method comprising the steps of:
transmitting to said mobile device a document list and a recipient list generated by said user computer;
displaying on said mobile device said document list and said recipient list for selection by a mobile user;
transmitting selected documents and selected recipients chosen by a mobile user to said user computer;
generating a message incorporating said selected documents; and
transmitting said message from said user computer to each of said selected recipients.

2. The method according to claim 1, wherein said document list is empty resulting in a message without an attachment.

3. The method according to claim 1, wherein said message content is selected by said mobile user.

4. The method according to claim 1, wherein said message comprises an email message.

5. The method according to claim 1, wherein said message comprises a Short Message Service (SMS) message.

6. The method according to claim 1, wherein said message comprises an instant messaging message.

7. The method according to claim 1, wherein said document list and said recipient list comprise really simple syndication (RSS) documents.

8. The method according to claim 1, wherein said recipient list is generated from data stored in a mobile user's personal information manager (PIM) application.

9. The method according to claim 1, further comprising the steps of:
receiving one or more manually entered recipient addresses from said mobile user; and
collecting said manually entered one or more recipient addresses into a Javascript array for review by said mobile user.

10. The method according to claim 1, further comprising the steps of:
receiving one or more manually entered recipient addresses from said mobile user; and
sending said manually entered one or more recipient addresses to a middleware application adapted to fill a container with said one or more recipient addresses for review by said mobile user.

11. A method of document interaction, for use on a mobile device, between a mobile device and a user computer in communication with each other via one or more communication networks, said method comprising the steps of:
displaying on said mobile device a document list and a recipient list to a mobile user for selection by a mobile user;
transmitting selected documents and selected recipients chosen by a mobile user to said user computer; and
receiving a confirmation message on said mobile device from said user computer indicating successful transmission of a message incorporating said selected documents to each of said selected recipients.

12. The method according to claim 11, wherein said document list is empty resulting in a message without an attachment.

13. The method according to claim 11, wherein said message content is selected by said mobile user.

14. The method according to claim 11, wherein said message comprises an email message.

15. The method according to claim 11, wherein said message comprises a Short Message Service (SMS) message.

16. The method according to claim 11, wherein said message comprises an instant messaging message.

17. The method according to claim 11, wherein said recipient list is generated from data stored in a mobile user's personal information manager (PIM) application.

18. A mobile client for document interaction with a user computer, said mobile client and said user computer in communication with each other via one or more communication networks, said mobile client comprising:
display means for displaying on said mobile device a document list and a recipient list to a mobile user and for receiving document selections and recipient selections chosen by a mobile user;
means for transmitting said selected documents and said selected recipients to said user computer; and
means for receiving a confirmation message on said mobile device from said user computer indicating successful transmission of a message incorporating said selected documents to each of said selected recipients.

19. The mobile client according to claim 18, wherein said display means comprises really simple syndication (RSS) reader.

20. The mobile client according to claim 18, wherein said display means comprises a web browser.

21. The mobile client according to claim 18, further comprising a middleware application operative to:
search for a predetermined page ID in requests from said mobile device to said user computer and retrieve corresponding actions to perform from a middleware action database when said page ID is found;
extract one or more items from said request in accordance with said actions to perform;
store said one or more items in session containers; and
refresh said page requested by said mobile user filling each container on said page with data stored in said session containers.

22. A computer program product, comprising:
a computer usable medium having computer usable program code for document interaction between a mobile device and a user computer in communication with each other via one or more communication networks, said computer program product including;
computer usable program code for displaying on said mobile device a document list and a recipient list to a mobile user for selection by a mobile user;
computer usable program code for transmitting selected documents and selected recipients chosen by a mobile user to said user computer; and
computer usable program code for receiving a confirmation message on said mobile device from said user computer indicating successful transmission of a message incorporating said selected documents to each of said selected recipients.

23. A method of document interaction, for use on a user computer, between a mobile device and a user computer in communication with each other via one or more communication networks, said method comprising the steps of:
providing a document list and a recipient list to a mobile device for selection by a mobile user;
receiving selected documents and selected recipients chosen by said mobile user;
generating a message incorporating said selected documents; and
transmitting said message from said user computer to each of said selected recipients.

24. The method according to claim 23, wherein said document list is empty resulting in a message without an attachment.

25. The method according to claim 23, wherein said message content is selected by said mobile user.

26. The method according to claim 23, wherein said message comprises an email message.

27. The method according to claim 23, wherein said message comprises a Short Message Service (SMS) message.

28. The method according to claim 23, wherein said message comprises an instant messaging message.

29. The method according to claim 23, wherein said recipient list is generated from data stored in a mobile user's personal information manager (PIM) application.

30. A computer program product, comprising:
a computer usable medium having computer usable program code for document interaction between a mobile device and a user computer in communication with each other via one or more communication networks, said computer program product including;
computer usable program code for providing a document list and a recipient list to a mobile device for selection by a mobile user;
computer usable program code for receiving selected documents and selected recipients chosen by said mobile user;
computer usable program code for generating a message incorporating said selected documents; and
computer usable program code for transmitting said message from said user computer to each of said selected recipients.

31. An apparatus for document interaction with a mobile device, said apparatus and said mobile user in communication with each other via one or more communication networks, said apparatus comprising:
an activity database for storing session based information related to generation of messages for transmission to one or more recipients;
a web server operative to receive requests from and to serve document and recipient lists to said mobile device;
a messaging application operative to generate and transmit messages to one or more recipients; and
an agent in communication with said activity database, said web server and said messaging application, said agent operative to generate said document and recipient lists for selection by a mobile user on said mobile device, to receive selected documents and selected recipients chosen by said mobile user and to generate and transmit a message containing said selected documents to each of said selected recipients.

32. The apparatus according to claim 31, wherein said message comprises an email message.

33. The apparatus according to claim 31, wherein said message comprises a Short Message Service (SMS) message.

34. The apparatus according to claim 31, wherein said message comprises an instant messaging message.

35. The apparatus according to claim 31, wherein said recipient list is generated from data stored in a mobile user's personal information manager (PIM) application.

36. The apparatus according to claim 31, wherein said agent is operative to:
store recipient addresses associated with a particular session received from said mobile device in said activity database; and
regenerate and transmit to said mobile device, via said web server, said recipient list including any recipient addresses recently added thereto; and
repeat said steps of storing, regenerating and transmitting until recipient selection by said mobile user is complete.
